(19) United States
(12) Patent Application Publication
(10) Pub. No.: US 2014/0092272 A1
(43) Pub. Date: Apr. 3, 2014

(54) APPARATUS AND METHOD FOR CAPTURING MULTI-FOCUS IMAGE USING CONTINUOUS AUTO FOCUS

(71) Applicant: Pantech Co., Ltd., Seoul (KR)

(72) Inventor: Dong-Eob CHOI, Seoul (KR)

(73) Assignee: Pantech Co., Ltd., Seoul (KR)

(21) Appl. No.: 14/028,996

(22) Filed: Sep. 17, 2013

(30) Foreign Application Priority Data
Sep. 28, 2012 (KR) 10-2012-0109400

(51) Int. Cl. H04N 5/232; G03B 13/36

(52) U.S. Cl. CPC H04N 5/23293; G03B 13/36
USPC 348/222.1

(57) ABSTRACT

The present disclosure relates to an apparatus and method for capturing a multi-focus image using continuous auto focus. The method for execution on a processor includes: providing a target including a plurality of target image areas; continuously auto-focusing an image capturing device to capture one or more temporary images of the plurality of target image areas; determining an Auto-Focus (AF) value for each target image area in the one or more temporary images; for the plurality of target image areas, selecting using the processor, a temporary image having a maximum AF value for the respective target image area; for the plurality of target image areas, linking using the processor, an image of the respective target image area from the selected temporary image associated with the respective target image area to obtain a multi-focus image.

### CROSS-REFERENCE TO RELATED APPLICATION

This application claims priority from and the benefit under 35 U.S.C. §119 of Korean Patent Application No. 10-2012-0109400, filed on Sep. 28, 2012, the entire disclosure of which is incorporated herein by reference in its entirety as if fully set forth herein for all purposes.

### BACKGROUND

1. Field

The following description relates to camera technology, and more particularly, to an apparatus and method for capturing a multi-focus image using continuous auto focus.

2. Discussion of the Background

A multimedia mobile terminal capable of providing various additional services, such as an electronic note function, a game function, a schedule management function, etc. has been developed. In particular, as cameras are installed in mobile terminals, users' demands to more conveniently capture images or moving images are increasing. In order to meet the users' demands, many mobile terminals with high definition, high pixel cameras have been introduced.

A conventional camera captures an image with a single focus. As such, a captured image provides only one optimized target, and if focusing fails, the camera fails to obtain a desired image.

In order to overcome the problem, a multi-focus camera has been developed and released. The multi-focus camera is configured by installing a plurality of micro lenses in the focus plane of a main lens, and uses software capable of analyzing small images received through the micro lenses and manipulating and combining the images to create an image in which a part selected by a user is focused. However, there are difficulties in applying the conventional multi-focus camera to a mobile terminal since the camera module has a large size and is expensive. In addition, the captured image has low resolution, and there are many hardware limitations since the constructive output from hardware is combined with software technology.

### SUMMARY

The following description relates to an apparatus and method for capturing a multi-focus image using continuous auto focus, and capable of outputting an image optimized for an area selected by a user by capturing a multi-focus image and linking a plurality of images with various focuses to the multi-focus image.

According to exemplary embodiments, there is provided a method for execution on a processor, the method including: continuously auto-focusing an image capturing device to capture one or more temporary images of a plurality of focus areas; determining an Auto-Focus (AF) value for each focus area in the one or more temporary images; for the plurality of focus areas, selecting, using the processor, a temporary image having a maximum AF value for the respective focus area; and for the plurality of focus areas, linking, using the processor, an image of the respective focus area from the selected temporary image associated with the respective focus area to obtain a multi-focus image.

According to exemplary embodiments, there is provided an image capturing device for a mobile apparatus, the image capturing device including: an auto focusing unit configured to be continuously auto-focusing to capture one or more temporary images of a plurality of focus areas; a controller configured to determine an Auto-Focus (AF) value for each focus area in the one or more temporary images, and configured to select, for the plurality of focus areas, a temporary image having a maximum AF value for the respective focus area; and an image link unit configured to link, for the plurality of focus areas, an image of the respective focus area from the selected temporary image associated with the respective focus area to obtain a multi-focus image.

According to exemplary embodiments, there is provided a method for execution on a processor, the method including: continuously auto-focusing an image capturing device to capture one or more temporary images of a plurality of focus areas; creating a multi-focus image of a target; for the plurality of focus areas, selecting, using the processor, a temporary image portion associated with the respective focus area, wherein the temporary image portion has a maximum AF value amongst the one or more temporary images for the respective focus area, to establish selected temporary image portions; linking, using the processor, the multi-focus image of the target with the selected temporary image portions; and displaying the linked multi-focus image.

Additional features of the invention will be set forth in the description that follows, and in part will be apparent from the description, or may be learned by practice of the invention.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 illustrates a multi-focus image capturing apparatus according to exemplary embodiments.

FIG. 2 illustrates a method of setting focus areas on a preview screen when a user's selection is provided according to exemplary embodiments.

FIG. 3 illustrates a method of creating and storing temporary images according to exemplary embodiments.

FIG. 4 illustrates a method of creating a multi-focus image according to exemplary embodiments.

FIG. 5 illustrates a method of linking images with maximum focus values to the multi-focus image according to exemplary embodiments.

FIG. 6 illustrates a method of setting focus areas when there is no user's selection according to exemplary embodiments.

FIG. 7 illustrates a method of creating and storing temporary images according to exemplary embodiments.

FIG. 8 illustrates a method of creating a multi-focus image according to exemplary embodiments.

FIG. 9 illustrates a method of setting focus areas when there is no user's selection according to exemplary embodiments.

FIG. 10 illustrates a method of creating and storing temporary images according to exemplary embodiments.

FIG. 11 illustrates a method of creating a multi-focus image according to exemplary embodiments.

FIG. 12 illustrates a multi-focus image capturing method according to exemplary embodiments.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. In addition, descriptions of well-known functions and constructions may be omitted for increased clarity and conciseness.

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

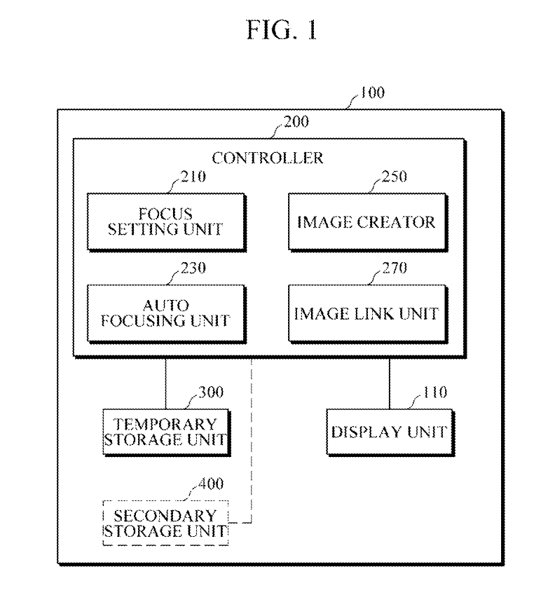

Hereinafter, an exemplary multi-focus image capturing apparatus 100 using continuous auto focus will be described with reference to FIG. 1 through FIG. 5.

FIG. 1 illustrates a multi-focus image capturing apparatus according to exemplary embodiments. The multi-focus image capturing apparatus 100 using continuous auto focus can photograph an object, provide a preview image to a user and store the photographed image. The multi-focus image capturing apparatus 100 may include, for example, a digital camera, a smart phone, a tablet PC, and a portable computer. In this specification, the term “image” includes a picture. In the following description, for convenience of description, the multi-focus image capturing apparatus 100 is assumed to be a smart phone, without limitation to other devices that can include a multi-focus image capturing apparatus.

When a user takes a picture while viewing a target to be photographed through a display 110, he or she may want to obtain a picture focused on an object among a plurality of objects displayed on the display 100 or a picture focused on several objects. The object of the focus can include, for example, a person, a thing, a background landscape, or the landscape itself. The term “photograph” has basically the same meaning as the term “capture”, but in the following description, for convenience of description, an operation in which a user obtains a target image, for example, by selecting a capture button, is referred to as “photograph;” and in an operation in which the multi-focus image capturing apparatus 100 obtains a target image before providing a final target image to a user is referred to as “capture”.

Sometimes a user wants to view all images focused on individual objects. The individual objects can have different focal distances, as they are likely located at different distances from the user. In this case, the user generally individually selects the objects to be photographed, and individually photographs the objects to obtain the images focused on the individual objects.

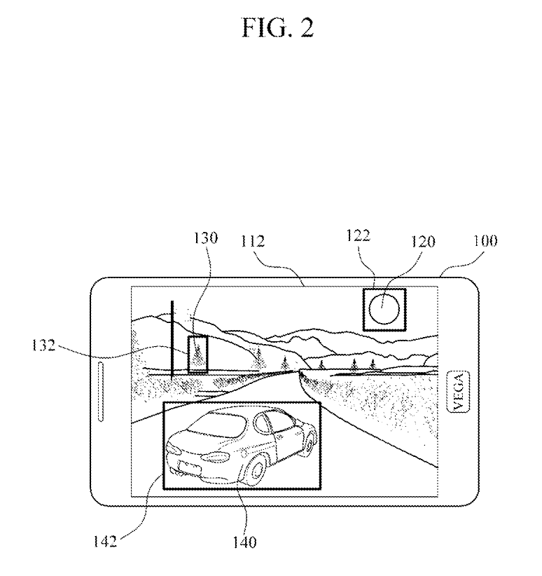

When, a user selects a plurality of objects to be photographed from a preview screen, for example, via a preview screen 112 of FIG. 2 displayed on the display 110, through a camera before photographing and takes a picture once, the multi-focus image capturing apparatus 100 automatically captures a plurality of images with different focal distances for the selected objects. The preview screen, for example, the preview screen 112 of FIG. 2, may be a screen in which an image is displayed and through which objects may be selected to be focal points of a multi-focus image. The multi-focus image capturing apparatus 100 can then select from the plurality of images to provide the multi-focus image for the user. The user may select a desired object from the multi-focus image, and in this case, the multi-focus image capturing apparatus 100 provides an image most properly focused on the selected object to the user. The image provided to the user may be stored by the user, and if the user selects “storing,” the multi-focus image may be displayed again. The user may select another object from the multi-focus image to check whether the selected object has been properly focused, and then finally store the multi-focus image. However, aspects need not be limited thereto such that the multi-focus image need not be displayed after storing and the multi-focus image capturing apparatus 100 may display another preview image, operate or close an application, and the like, after storing the multi-focus image.

Through the process described above, although the user takes a picture once, the user can obtain an image focused on a plurality of desired objects since the multi-focus image capturing apparatus 100 captures a plurality of images. If the user selects no object, the multi-focus image capturing apparatus 100 may select objects that are larger than a predetermined or set size from the preview screen 112 to create a multi-focus image, or the multi-focus image capturing apparatus 100 may divide the preview screen 112 into a number of areas each having a size to create a multi-focus image.

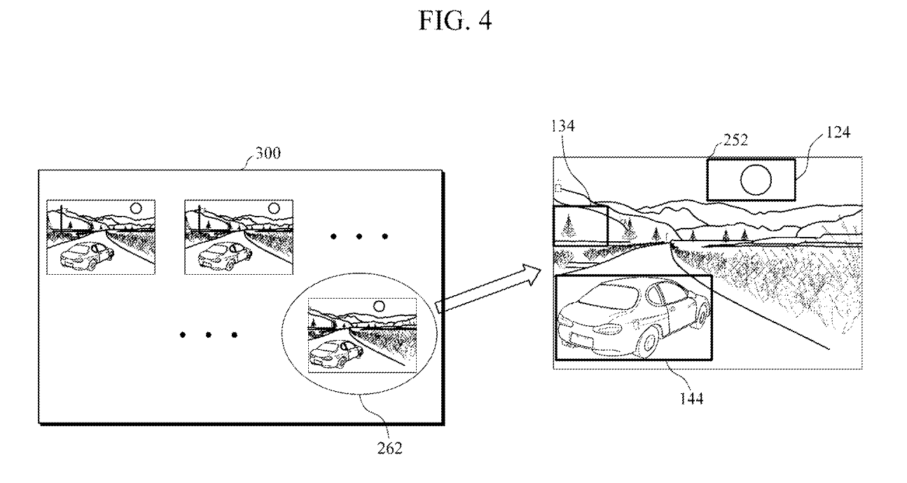

The multi-focus image includes a representative image selected from among a plurality of images captured and stored as described in reference to FIG. 4. The multi-focus image can include an image linked to an image or portions of an image most properly focused on each of objects selected by the user or on each of predetermined objects.

The multi-focus image capturing apparatus 100 of FIG. 1 can also be a camera for photographing objects. The multi-focus image capturing apparatus 100 can include a display 110 for providing either a preview screen to a user before photographing objects or a photograph view screen after photographing objects, and a capture button (not shown) implemented either as a physical button or a software button on the display 110.

The multi-focus image capturing apparatus 100 includes a controller 200 for creating a multi-focus image using continuous auto focus in order to provide an image focused on the user's desired target(s), and a temporary storage unit 300 for temporarily storing captured images. The multi-focus image capturing apparatus 100 may include a secondary storage unit 400 for temporarily storing an image selected by a user before it is stored in a final storage unit.

The controller 200 includes a focus setting unit 210, an auto focusing unit 230 for executing continuous auto focus at each focal distance and capturing images, an image creator 250 for creating a multi-focus image, and an image link unit 270 for linking a target selected by a user from the multi-focus image to an actually captured image.

The focus setting unit 210 may set one or more focus areas according to the user's selection. FIG. 2 illustrates a method of setting focus areas on a preview screen when a user's selection is provided according to exemplary embodiments. If the user selects a plurality of objects from the preview screen 112, the focus setting unit 210 sets a focus for each object, and may set focus areas 122, 132, and 142 including areas of the objects or including the objects and peripheral areas around the objects.

A focus area may be set to the center area of an object or to a predetermined size of area on an object. When the size of an object is relatively accurately detected, a focus area may be set to a size similar to the size of the object. When the size of an object is not clearly detected, a focus area may be set to an area that is more or less larger than the object, including the object and a peripheral area around the object.

The focus area includes information about a high frequency component value (an Auto-Focus (AF) value) passed through a High Pass Filter (HPF) which filters high frequency components and is generally included in a camera. The focus areas of images captured at different focal distances with respect to the same object show different AF values. Generally, the greater the AF value of a focus area with respect to an object, the more properly the corresponding image is focused on the object. AF values are stored in correspondence to focus areas when captured images are stored in, for example, the temporary storage unit 300. The greatest value of AF values is referred to as a maximum focus value.

The focus areas 122, 132, and 142 for the respective objects may be, as shown in FIG. 2, denoted by guidelines to provide the user with information about the focus areas 122, 132, and 142.

Referring to FIG. 2, when the user selects objects, for example, a sun 120, a tree 130, and a car 140 as objects on which to focus, the focus setting unit 310 can set areas including the sun 120, tree 130, and car 140, and predetermined peripheral areas around the sun 120, tree 130 and car 140, to corresponding focus areas 122, 132, and 142. The focus areas 122, 132, and 142 are surrounded by rectangular guidelines and displayed on the preview screen 112. Thereafter, if the user drives the capture button (not shown) to take a picture, the following exemplary process is performed.

The auto focusing unit 230 moves a lens (not shown) to focus on a selected target object to execute a continuous auto focus feature. A feature of moving a lens and fixing the lens at a location most properly focused on an object is auto focus, and the continuous auto focus is a feature of performing auto focus when there is a change of objects (for example, when the preview screen 112 moves and a frame changes).

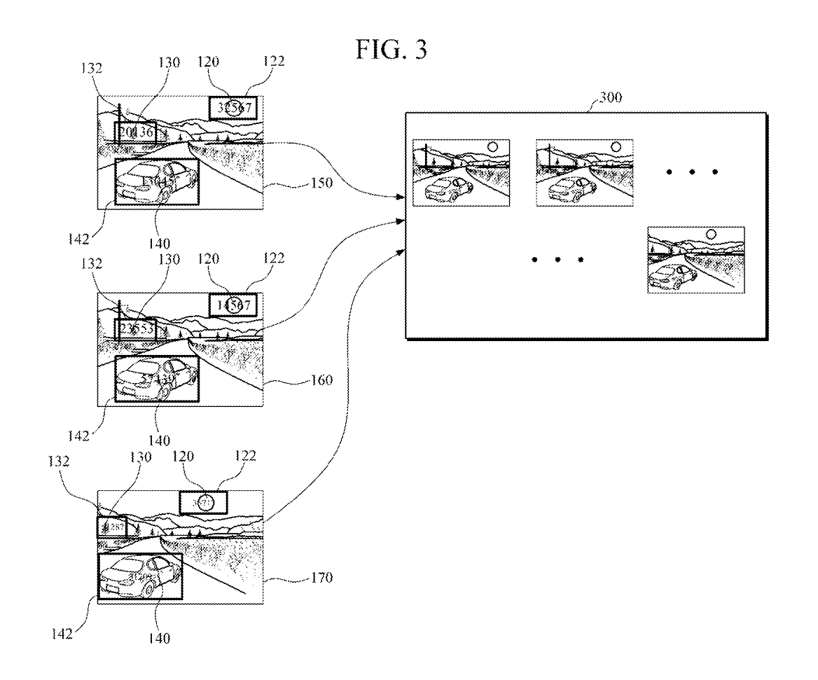

When a user selects an object while viewing the objects through the preview screen 112, a frame can change or a change of objects can occur due to movement of an object. In the current example, the auto focusing unit 230 performs the continuous auto focus. While executing the continuous auto focus, the auto focusing unit 230 captures a predetermined number of images at each focal distance, wherein the captured images are referred to as temporary images since they are not images finally stored by the user. That is, when the user drives the capture button one time, a predetermined number of images are actually captured, as shown in FIG. 3. However, aspects need not be limited thereto such that the temporary images may be set to be stored or transmitted.

The captured temporary images are stored in the temporary storage unit 300. In some embodiments, the auto focusing unit 230 may continue to capture temporary images while executing the continuous auto focus, until the user actually drives the capture button after the user has selected an object through the preview screen 112, i.e., from a time when a first object is selected until the capture button is pressed. In some embodiments, all of the captured temporary images are stored in the temporary storage unit 300, and when the user drives the capture button, a predetermined or set number of temporary images captured in reverse temporal order from when the user drives the capture button may be selected to be provided to the user.

The auto focusing unit 230 may capture a number of images corresponding to at least the number of objects selected by the user in order to acquire images properly focused on the selected objects. However, the auto focusing unit 230 may capture a number of images greater than or equal to the number of objects selected by the user at each focal distance. For example, the number of images that are captured while the continuous auto focus is executed may be set to 20, 30 or greater.

FIG. 3 illustrates a method of creating and storing temporary images according to exemplary embodiments. In a first temporary image 150, exemplary focus values of the focus areas 122, 132, and 142 of objects 120, 130, and 140 are 32567, 20136, and 13045, respectively. In a second temporary image 160, the focus values of the focus areas 122, 132, and 142 of objects 120, 130, and 140 are 14567, 23553, and 57439, respectively. In a third temporary image 170, the focus values of the focus areas 122, 132, and 142 of the objects 120, 130, and 140 are 35712, 51287, and 31209, respectively. As described, each focus area has different focus values with respect to the respective captured images, and the captured images with the different focus values are stored in the temporary storage unit 300.

FIG. 4 illustrates a method of creating a multi-focus image according to exemplary embodiments. The image creator 250 selects a representative image 262 from among the images stored in the temporary storage unit 300. The representative image 262 is then transformed into a multi-focus image 252 by including information about the focus areas, such as, objects selected by the user from the preview screen 112. The image creator 250 may arbitrarily select the representative image 262. The image creator 250 provides the multi-focus image 252 to the user. The image creator 250 may be set to select the representative image 262 according to focus areas, focus values of focus areas, image properties, and the like. The image creator 250 may create guidelines 124, 134, and 144 on the created multi-focus image 252 to represent areas of the objects selected by the user. The guidelines 124, 134, and 144 may be displayed to represent the same areas as the corresponding focus areas, or to represent new sizes including the objects and arbitrary peripheral areas around the objects. Whether or not the guidelines 124, 134, and 144 are displayed may depend on the user's setting. In some embodiments, the guidelines in the created multi-focus image 252 correspond to the focus areas.

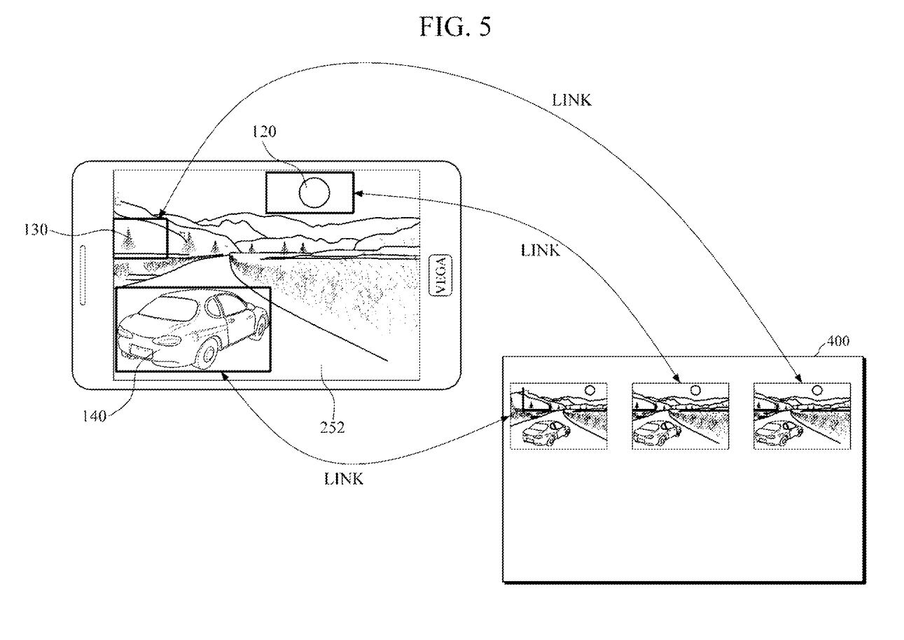

FIG. 5 illustrates a method of linking images with maximum focus values to the multi-focus image according to exemplary embodiments. In exemplary embodiments, the image link unit 270 links images with maximum focus values with respect to the individual focus areas to the multi-focus image 252 created by the image creator 250. Each object that is the target of a focus area and selected by the user or represented by guidelines on the multi-focus image 252 has different focus values according to focal distances between the plurality of captured images. Since there will be an image with a maximum focus value among the plurality of images, an image with a maximum focus value with respect to each object (or a focus area) selected by the user or represented by guide lines may be linked to the multi-focus image 252. Accordingly, if the user selects a specific object on the multi-focus image 252, the image link unit 270 may link an image with a maximum focus value with respect to the selected object to the multi-focus image 252, and provide the resultant image to the user.

The temporary storage unit 300 temporarily stores the plurality of images captured by the auto focusing unit 230 when the auto focusing unit 230 executes the continuous auto focus, and also temporarily stores the multi-focus image 252 created by the image creator 250 (see FIG. 3). The stored images include focus values according to focal distances about each of the focus areas of objects selected by the user or predetermined objects, or about each of predetermined, divided focus areas. The temporary storage unit 300 can include a relatively fast memory, for example, as compared to the secondary storage unit 300. The faster memory can permit for fast capture of successive images, for example, when capturing a plurality of images of a target at various focal distances. In some embodiments, the temporary storage unit 300 may be separately provided or integrated with the multi-focus capturing apparatus 100. For example, the temporary storage unit 300 may be provided by cloud storage or in an external memory card.

The image link unit 270 links an image with a maximum focus value with respect to each object among the images stored in the temporary storage unit 300, to the multi-focus image 252. For example, if the user selects three objects, and 21 images are captured at each focal distance, the 21 images have different focus values for each object. With respect to one object, one of the 21 images has a focus value higher than the focus values with respect to that one object in the remaining 20 images. The image with that higher focus value is an image with a maximum focus value among the 21 images. The image link unit 270 detects the image with the maximum focus value, and links the image to the multi-focus image 252.

The linking can include generating a composite image including one or more of the temporary images captured at various focal distances for a target. In some embodiments, the linking can include copying image data from one or more of the temporary images to the multi-focus image. In some embodiments, the linking can include overwriting portions of multi-focus image data from one or more of the temporary images. In some embodiments, the linking can include recording meta-data or references to one or more of the temporary images in the multi-focus image.

The images stored in the temporary storage unit 300 may be all deleted when the user terminates the creating the multi-focus image after acquiring all desired images from the multi-focus image 252. However, aspects need not be limited thereto such that the images stored in the temporary storage unit 300 need not be deleted but may be overwritten by later operations or stored in the temporary storage unit 300 or other storage unit.

The secondary storage unit 400 may extract the multi-focus image 252 created by the image creator 250 and store the multi-focus image 252. In some embodiments, the secondary storage unit 400 may extract an image with a maximum focus value extracted by the image link unit 270 from the temporary storage unit 300 and linked to the multi-focus image, and store the image with the maximum focus value. The image stored in the secondary storage unit 400 need not be deleted before the user deletes the image. If the user selects the multi-focus image 252 and the image with the maximum focus value stored in the secondary storage unit 400 to store the images, the secondary storage unit 400 may move the images to an external memory or an internal memory and then may delete the moved images from the secondary storage unit 400. The secondary storage unit 400 may be separately provided or integrated with the temporary storage unit 300. In some embodiments, the secondary storage unit 400 may be separately provided or integrated with the multi-focus capturing apparatus 100. For example, the secondary storage unit 400 may be provided by cloud storage or in an external memory card.

Now, a method of selecting the image with the maximum focus value will be described in more detail with reference to FIG. 3.

For example, if the focus values of the focus area 122 corresponding to the object 120 are 32567 in the first temporary image 150, 14567 in the second temporary image 160, 35712 in the third temporary image 170, and 48721 in the sixth temporary image (not shown), the sixth temporary image is selected as an image with a maximum focus value corresponding to the object 120 since the sixth temporary image has the maximum focus value.

Likewise, an image with a maximum focus value with respect to the focus area 132 corresponding to the object 130, and an image with a maximum focus value with respect to the focus area 142 corresponding to the object 140 are selected. The selected images with the maximum focus values are stored in the secondary storage unit 400.

In the example, the controller 200 can be configured with the focus setting unit 210, the auto focusing unit 210, the image creator 250, and the image link unit 270, and controls for them. The controller 200 may control all configurations and processes for capturing images and creating a multi-focus image, from a lens module to the secondary storage unit 400.

Controller 200 can capture the temporary images at the plurality of targets within a fixed period or duration of time. The period for capturing all of the temporary images can be short, for example, less than 0.5 seconds, less than 1 second, less than 5 seconds, less than 15 seconds, less than 30 seconds, and the like. In some embodiments, the period for capturing all of the temporary images can be elongated to compensate for, for example, a relatively slow auto focusing unit 230; the interval can be set as, for example, less than 1 minute, less than 5 minutes.

In some embodiments, controller 200 can utilize an image stabilization feature (not shown) of the multi-focus capturing apparatus 100 for the period or duration of time that the temporary image capture is occurring. In some embodiments, controller 200 can override a user's setting for using the image stabilization feature of the multi-focus capturing apparatus 100.

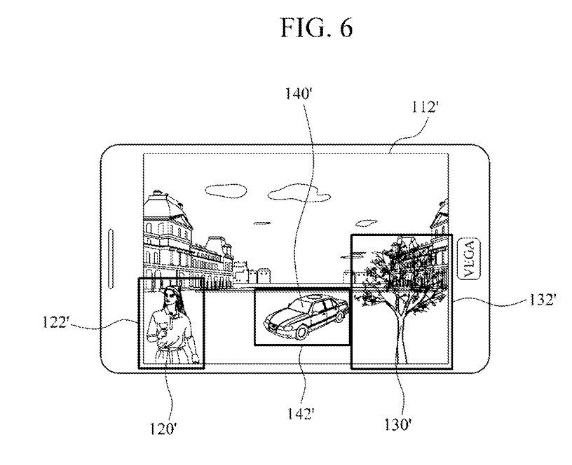

A multi-focus image capturing apparatus using the continuous auto focus is described with reference to FIG. 6 through FIG. 8. In the following description, detailed descriptions for the same may be omitted.

FIG. 6 illustrates a method of setting focus areas when there is no user's selection according to exemplary embodiments. If a user selects no specific object from a preview screen 112′, the focus setting unit 210 may automatically focus on objects 120′, 130′, and 140′ that are larger than a predetermined size. The focus setting unit 210 focuses on the target objects 120′, 130′, and 140′, and sets focus areas 122′, 132′ and 142′ either including the center areas of the objects 120′, 130′, and 140′ or including the objects 120′, 130′, and 140′ and predetermined peripheral areas around the objects 120′, 130′, and 140′. The focus areas may be represented by guide lines so that the user can recognize the objects 120′, 130′, and 140′.

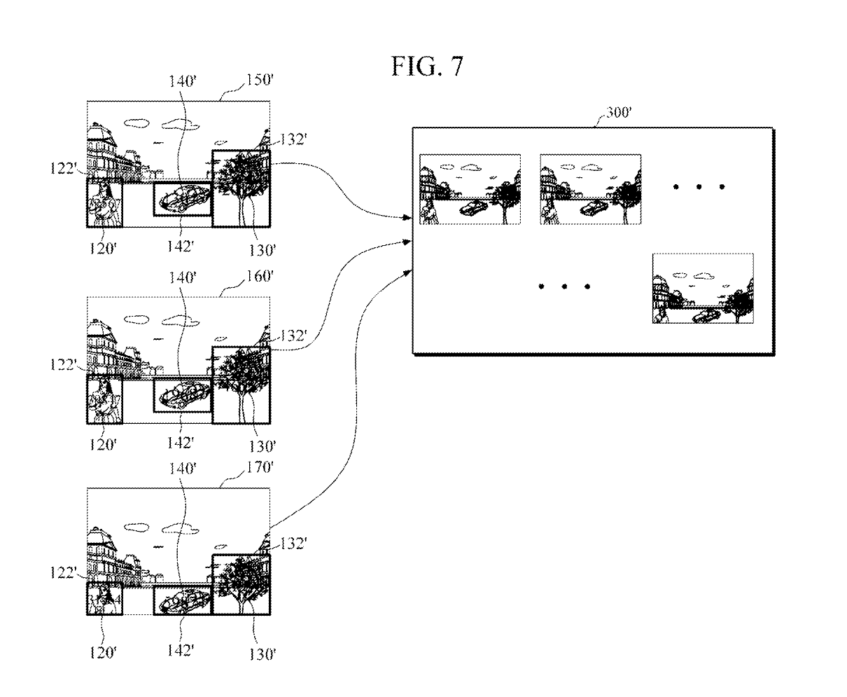

Auto focusing unit 230 captures a predetermined number of images while executing the continuous auto focus, and the captured images are stored in a temporary storage unit 300′ of FIG. 7. Since the focus setting unit 210 has selected the objects 120′, 130′, and 140′ that are to be focused without the user selecting an object, the auto focusing unit 230 performs the continuous auto focus at each focal distance based on the focus areas 122′, 132′, and 142′ set by the focus setting unit 210. Temporary images 150′, 160′ and 170′ captured at each focal distance with respect to each focus area by performing the continuous auto focus are stored in the temporary storage unit 300′ (see FIG. 7).

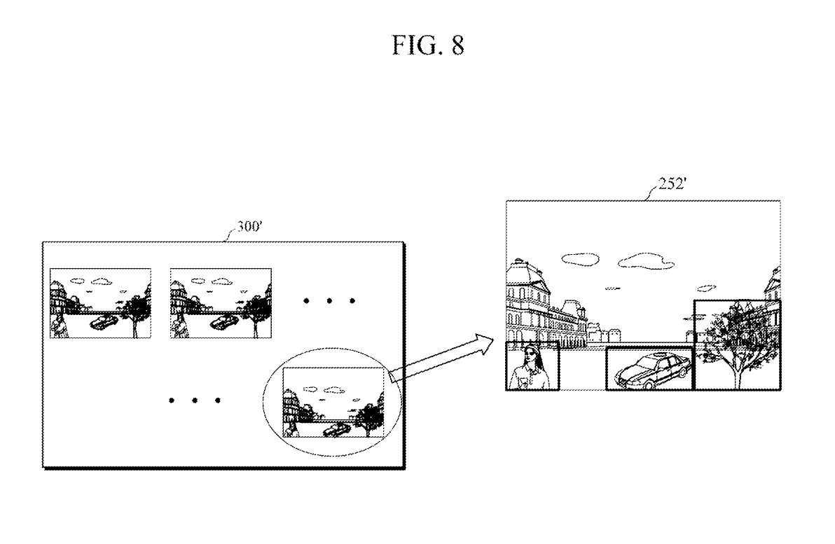

FIG. 8 illustrates a method of creating a multi-focus image according to exemplary embodiments. An image creator 250 creates a multi-focus image 252′, and image link unit 270 links an image with a maximum focus value for each object to the multi-focus image 252′.

If the user selects a specific object from the multi-focus image 252′, the image link unit 270 may link an image with a maximum focus value with respect to the selected object to the multi-focus image 252′, and provide the resultant image to the user.

The temporary storage unit 300′ and the secondary storage unit 400′ perform the same functions as the temporary storage unit 300 and the secondary storage unit 400 and accordingly, detailed descriptions thereof may be omitted.

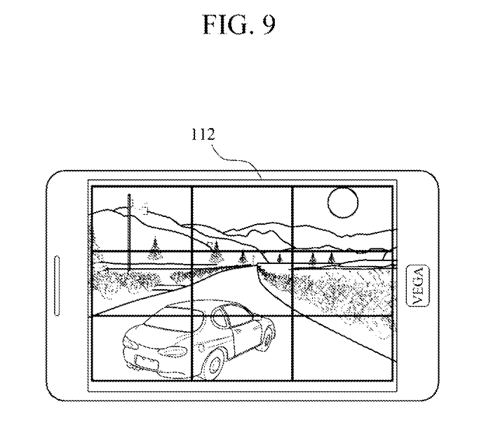

A multi-focus image capturing apparatus using the continuous auto focus, according to exemplary embodiments, is described with reference to FIG. 9 through FIG. 11. In the following description, detailed descriptions for the same configurations may be omitted.

FIG. 9 illustrates a method of setting focus areas when there is no user's selection according to exemplary embodiments. If a user selects no specific object from a preview screen 112, a focus setting unit 210 may divide the preview screen 112 to a predetermined number of areas each having a predetermined size, and automatically focus on each divided area. At this time, each divided area becomes a focus area that is set by the focus setting unit 210. Each focus area may be represented by guidelines so that the user can recognize the focus area.

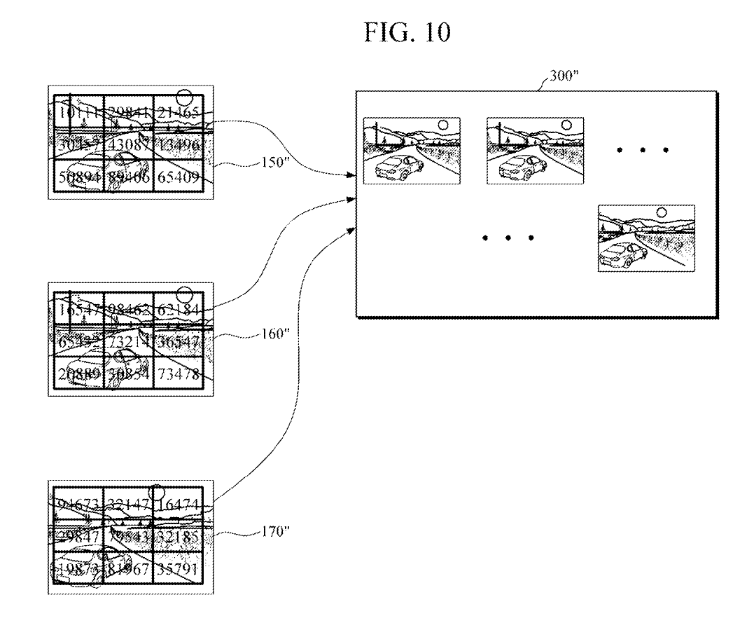

Auto focus executing unit 230 captures a predetermined number of images while performing the continuous auto focus, and the captured images are stored in a temporary storage unit 300″ (see FIG. 10). The predetermined number of images that are captured may be identical to the number of the divided areas. In some embodiments, the predetermined number of images that are captured is set to a value that is greater than the number of the divided areas. In some embodiments, the predetermined number of images that are captured is set to a value that is a multiple of the divided areas. For example, if the number of the divided areas is 10, the number of images that are captured may be set to 30 or 40.

Since the focus setting unit 210 has set each divided area to a focus area while the user has selected no specific object, the auto focusing unit 230 performs the continuous auto focus at each focal distance based on the focus areas set by the focus setting unit 210. Temporary images 150″, 160″ and 170″ captured at each focal distance with respect to each focus area by performing the continuous auto focus are stored in the temporary storage unit 300″ (see FIG. 10).

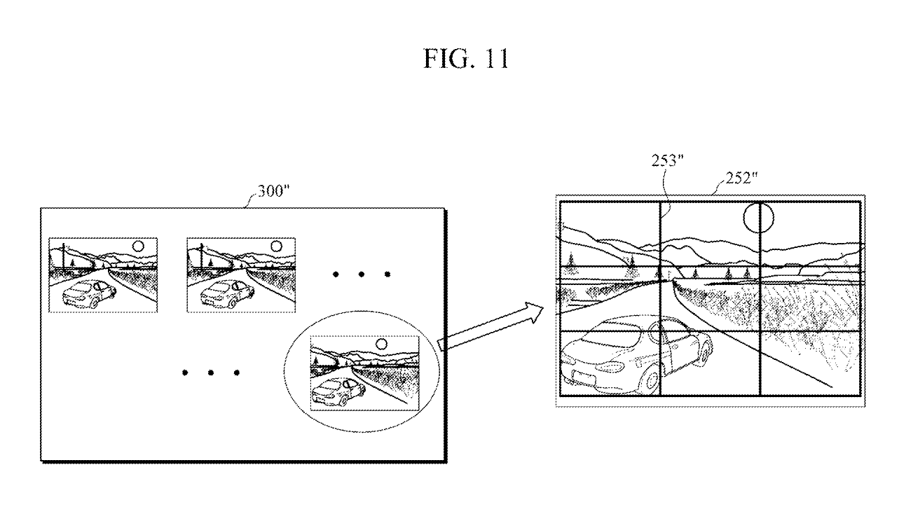

FIG. 11 illustrates a method of creating a multi-focus image according to exemplary embodiments. Image creator 250 creates a multi-focus image 252″, and an image link unit 270 links an image with a maximum focus value with respect to each divided area, as illustrated by guidelines 253″, to the multi-focus image 252″.

If the user selects a specific area on the multi-focus image 252″, the image link unit 270 may link an image with a maximum focus value with respect to the corresponding area to the multi-focus image 252″, and provide the resultant image to the user.

The temporary storage unit 300″ and the secondary storage unit 400″ perform the same functions as the temporary storage unit 300 and the secondary storage unit 400, and accordingly, detailed descriptions thereof may be omitted.

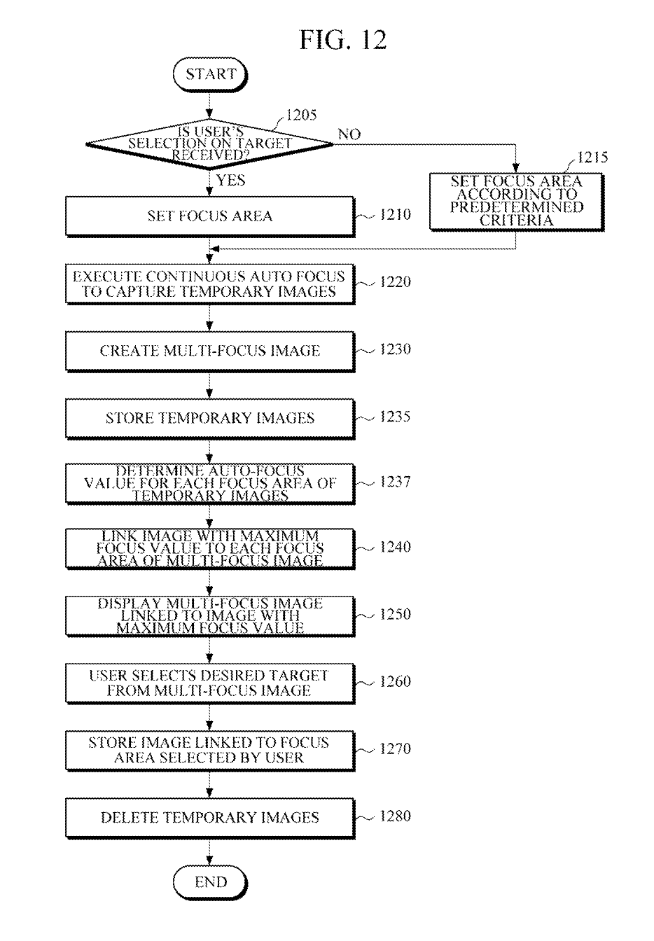

FIG. 12 illustrates a multi-focus image capturing method according to exemplary embodiments. A method of capturing a multi-focus image using the continuous auto focus will be described based on the above descriptions about the multi-focus image capturing apparatuses using the continuous auto focus. In the following description, like reference numerals are used to denote identical components, and detailed descriptions about the functions of the corresponding components may be omitted.

The multi-focus image capturing apparatus 100 using the continuous auto focus sets at least one focus area (1210). The focus area may be set, for example, by receiving a target to be set to a focus area from a user (1205), or, for example, according to predetermined or set criteria if there is no user's selection (1215). The criteria may correspond to an object that is displayed on a preview screen and larger than a desired size, or each of a number of areas divided from the preview image and each having a desired size. The object or the divided area according to the criteria may be set to a focus area.

For example, if a user selects at least one object from a preview screen, a focus area may be set based on the object selected by the user. At this time, an object tracking function may be executed. Each focus area has a high frequency component value (AF value) passed through a HPF at each focal distance, and the focus areas of images captured at different focal distances with respect to the same object show different AF values. AF values are stored in correspondence to focus areas when captured images are stored in the temporary storage unit 300.

Then, the continuous auto focus is executed while a lens moves to each focal distance with respect to each focus area set by the user's selection or according to the predetermined criteria, to thereby capture a predetermined number of images (1220). A number of images that are captured at each focal distance may be set to a number greater than or equal to the number of objects selected by the user so that the user can obtain an image properly focused on each desired object. In some embodiments, a number of images that are captured at each focal distance may be set to the number or more of objects automatically selected at each focal distance, or to the number or more of the divided areas. In some embodiments, the number of captured images can be a multiple of the number of desired objects.

The multi-focus image capturing apparatus 100 arbitrarily selects one from among the captured images, reflects information about the set focus areas to the selected image to create a multi-focus image 252 (1230). The images (that is, temporary images) captured in operation 1220 and the multi-focus image created in operation 1230 are stored in the temporary storage unit 300 (1235). An auto-focus value for each of the focus areas is determined (1237) for the temporary images. In some embodiments, the AF values are for the focus areas are measured and provided with the image. In some embodiments, a processor calculates the AF values of the focus areas.

On the multi-focus image 252, each focus area may be represented by guide lines, etc. An image with a maximum focus value with respect to each focus area may be linked to the multi-focus image 252 (1240). The temporary image with the maximum focus value for each of the focus areas can be selected from the group or set of temporary images that include an image of the focus area.

The multi-focus image 252 to which the image with the maximum focus value has been linked is provided to the user (1250), and the user may select a desired object or a desired divided area from the multi-focus image 252 (1260). If the user selects a desired object, an image with a maximum focus value to the corresponding object can be provided to the user, and the multi-focus image 252 and the image with the maximum focus value can be stored in the secondary storage unit 400 (1270).

The temporary images stored in the temporary storage unit 300 in operation 1235 may be deleted in operation 1280.

According to the configuration and method described above, when a user takes a picture, a plurality of images at each focal distance with respect to a plurality of targets selected by the user or according to a predetermined criteria can be obtained. An image of the picture can be provided to the user. The image can include links to one or more images properly focused on each of selectable targets. When the user selects desired targets from the provided image, he or she can acquire an image properly focused on the different targets through one capturing process.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

It will be apparent to those skilled in the art that various modifications can be made in the aspects of the present invention without departing from the spirit or scope of the invention. Thus, it is intended that the present invention cover the modifications and variations of this invention provided they come within the scope of the appended claims and their equivalents.

What is claimed is:

1. A method for execution on a processor, the method comprising:
continuously auto-focusing an image capturing device to capture one or more temporary images of a plurality of focus areas;
determining an Auto-Focus (AF) value for each focus area in the one or more temporary images;
for the plurality of focus areas, selecting, using the processor, a temporary image having a maximum AF value for the respective focus area; and
for the plurality of focus areas, linking, using the processor, an image of the respective focus area from the selected temporary image associated with the respective focus area to obtain a multi-focus image.

2. The method of claim 1, further comprising previewing a target and wherein at least one of the plurality of focus areas comprises a focus area selected by a user during the previewing.

3. The method of claim 1, wherein at least one of the plurality of focus areas is determined by selecting an object in a target, wherein the object has an image area greater than a minimum image area.

4. The method of claim 1, wherein the plurality of focus areas comprises divided areas of a target image.

5. The method of claim 1, wherein the continuously auto-focusing captures the one or more temporary images in a short duration.

6. The method of claim 5, wherein the continuously auto-focusing captures the one or more temporary images after a user action marks a beginning of the short duration and the short duration is less than 5 seconds.

7. The method of claim 1, wherein the one or more temporary images comprises an image comprising a plurality of focus areas.

8. The method of claim 1, wherein the linking comprises generating a composite of one or more of the selected temporary images.

9. The method of claim 1, further comprising displaying the multi-focus image comprising information about the plurality of focus areas.

10. The method of claim 9, further comprising receiving a selection of one or more of the focus areas from the multi-focus image.

11. The method of claim 1, wherein the AF value comprises a high frequency component value passed through a High Pass Filter (HPF).

12. An image capturing device for a mobile apparatus, the image capturing device comprising:
an auto focusing unit configured to continuously auto-focus to capture one or more temporary images of a plurality of focus areas;
a controller
configured to determine an Auto-Focus (AF) value for each focus area in the one or more temporary images, and
configured to select, for the plurality of focus areas, a temporary image having a maximum AF value for the respective focus area; and
an image link unit configured to link, for the plurality of focus areas, an image of the respective focus area from the selected temporary image associated with the respective focus area to obtain a multi-focus image.

13. The image capturing device of claim 12, further comprising a display to preview a target and wherein at least one of the plurality of focus areas comprises a focus area selected by a user.

14. The image capturing device of claim 12, wherein the controller is configured to select at least one of the plurality of focus areas from an object in a target having an image area greater than a minimum image area.

15. The image capturing device of claim 12, wherein the controller is configured to set the plurality of focus areas by dividing areas of a target image.

16. The image capturing device of claim 12, wherein the auto-focusing unit captures the temporary image sets in a short duration.

17. The image capturing device of claim 12, wherein the auto-focusing unit captures the temporary image sets after a user action marking a beginning of the short duration and the short duration is less than 5 seconds.

18. The image capturing device of claim 12, wherein the one or more temporary images comprises an image comprising a plurality of focus areas.

19. The image capturing device of claim 12, wherein the image link unit is configured to generate a composite of one or more of the selected temporary images.

20. The image capturing device of claim 12, further comprising a display configured to display the multi-focus image comprising information about the plurality of focus areas.

21. The image capturing device of claim 20, wherein the controller receives a selection of one or more of the focus areas of the multi-focus image.

22. The image capturing device of claim 12, further comprising a High Pass Filter (HPF) and the AF value comprises a high frequency component value passed through the HPF.

23. A method for execution on a processor, the method comprising:
continuously auto-focusing an image capturing device to capture one or more temporary images of a plurality of focus areas;
creating a multi-focus image of a target;
for the plurality of focus areas, selecting, using the processor, a temporary image portion associated with the respective focus area, wherein the temporary image portion has a maximum AF value amongst the one or more temporary images for the respective focus area, to establish selected temporary image portions;
linking, using the processor, the multi-focus image of the target with the selected temporary image portions; and
displaying the linked multi-focus image.
